(19) United States
(12) Patent Application Publication
(10) Pub. No.: US 2018/0019959 A1
(43) Pub. Date: Jan. 18, 2018

(54) COMMUNICATION SYSTEM WITH HIDDEN CONTENT AND METHOD THEREOF

(71) Applicant: HON-DA SHING, Taipei City (TW)

(72) Inventor: HON-DA SHING, Taipei City (TW)

(21) Appl. No.: 15/650,084

(22) Filed: Jul. 14, 2017

Related U.S. Application Data
(60) Provisional application No. 62/362,212, filed on Jul. 14, 2016.

(30) Foreign Application Priority Data
Dec. 9, 2016 (TW) 105140922

(51) Int. Cl. H04L 12/58; G06F 21/60; G06F 21/62; H04L 29/06

(52) U.S. Cl. CPC H04L 51/04; H04L 63/0428; H04L 63/08; G06F 21/606; G06F 21/6245; H04L 2209/60

(57) ABSTRACT

A communication system with hidden content and the method thereof are provided. The communication system with hidden content includes a device at the transmitting end, a communication server, and a device at the receiving end. The device at the transmitting end generates a communication message that includes viewable content and hidden content, and the hidden content has an unlock condition. The communication server generates a concealed message according to the communication message and the unlock condition. The device at the receiving end receives the concealed message, and when the unlock condition is met, the device at the receiving end displays the hidden content in the concealed message.

### CROSS-REFERENCE TO RELATED APPLICATION

This application claims priority from Taiwan Patent Application No. 105140922, filed on Dec. 9, 2016, at the Taiwan Intellectual Property Office, and U.S. Provisional Patent Application No. 62/362,212, filed on Jul. 14, 2016, at the United States Patent and Trademark Office, the content of which is hereby incorporated by reference in its entirety for all purposes.

### BACKGROUND OF THE INVENTION

### 1. Field of the Invention

The present invention is related to a communication system and a communication method thereof. More specifically, the present invention is related to a communication system with hidden content functionality, in which certain unlock conditions have to be met in order to view the hidden content.

### 2. Description of the Related Art

Nowadays, with the wide availability of smartphones and other devices, instant messaging has become an important form of communication with a large and growing user base. Often these conversations over instant messaging involve pledges, wagers, polls, or deals that are generally recorded for retrospective examination or confirmation. However, if the results of these interactions are not recorded right after the conversation, disputes or confusions may arise later on, especially if one of the parties decides to back out of or attempts to conceal their change in position in a previous pledge, wager, poll opinion or deal. Another issue is the effect that poll results might be influenced, if the accumulated opinions can be viewed before the poll closes, and this could run counter to the intended purpose of an opinion poll.

On the other hand, when many people are in a messaging chat room and certain topics are brought up, then some people might not be interested in those topics, might find them annoying, and would likely ignore those messages or post something that might negatively alter the mood of the chat room. The chat room might also be flooded with messages that are not relevant to the main purpose of the chat room, thus causing inconvenience to other users of the chat room.

### SUMMARY OF THE INVENTION

A communication system with hidden content and method thereof are disclosed herein to overcome the aforementioned problems. The communication system with hidden content, method thereof and alternate preferred embodiments of system and method thereof are hereinafter described to include two devices. However, the inventive concept disclosed herein is not limited to two devices, as a person of ordinary skill in the art may easily see how the inventive concept may be extended to three or more devices participating in one conversation using the disclosed invention.

To this aim, a communication system with hidden content is provided, which may include a first device, a communication server, and a second device. The communication system with hidden content may be employed as follows. The first device generates a communication message and displays a first communication interface that includes the communication message. The communication message may include viewable content and hidden content, and the hidden content is disposed with an unlock condition. The first device connects to and transmits the communication message to the communication server. The communication server receives the communication message and, according to the communication message and the unlock condition, generates a concealed message including the hidden content that is not displayed. The communication server connects to and transmits the concealed message to the second device. The second device receives the concealed message and displays a second communication interface, which includes the concealed message. The second communication interface displays the hidden content in the concealed message when the unlock condition is satisfied. The first device transmits first chat content through the communication server to the second device, and the first chat content is displayed in the second communication interface. The second device transmits second chat content through the communication server to the first device, and the second chat content is displayed in the first communication interface.

In one preferred embodiment, an application program corresponding to the communication server is installed on the first device, and the application program is logged into prior to the generation of the communication message.

In one preferred embodiment, the application program is installed on the second device to, for instance, display the second communication interface upon reception of the concealed message.

In one preferred embodiment, the communication server transmits the concealed message to the second device that does not have the application program installed, by means of communication that may not correspond to the application program.

In one preferred embodiment, the first device is configured to assign at least one contact to receive the communication message, and the communication server may generate a contact group according to the at least one contact.

In one preferred embodiment, the communication server generates another concealed message, a next concealed message including hidden content of the second chat content or of a further instance of the first chat content, the next concealed message also having an unlock condition.

Also to overcome the aforementioned problems, a communication method with hidden content is further provided in the present disclosure. The method may be applied to the communication system with hidden content. The communication system with hidden content may include a first device, a second device, and a communication server. The communication method with hidden content may include steps as follows: generating a communication message, which may have viewable content and hidden content, and setting an unlock condition corresponding to the hidden content; displaying a first communication interface that includes the communication message; generating, according to the hidden content and the unlock condition, a concealed message by the communication server, and then delivering the concealed message to the second device; displaying a second communication interface that includes the concealed message; and when the unlock condition is satisfied, displaying the hidden content in the concealed message. The first device transmits first chat content through the communication server to the second device, and the first chat content is displayed in the second communication interface. The second device transmits second chat content through the communication server to the first device, and the second chat content is displayed in the first communication interface.

In one preferred embodiment, prior to generating the communication message, the following steps may be included: installing on the first device an application program corresponding to the communication server; and logging into the application program.

In one preferred embodiment, the application program is installed on the second device, and the communication method includes the following step: receiving the concealed message and displaying the second communication interface accordingly by the second device.

In one preferred embodiment, the application program is not installed on the second device, and the communication method includes the following step: transmitting the concealed message by means of communication that does not correspond to the application program.

In one preferred embodiment, after the first device generates the communication message, the communication method includes the following steps: assigning at least one contact to receive the communication message; and generating a contact group according to the at least one contact.

In one preferred embodiment, prior to transmitting the second chat content or a further instance of the first chat content, the communication method includes the following steps: the corresponding second or first device generating the second chat content or the further instance of the first chat content that include hidden content, setting an unlock condition, and the communication server generating another concealed message according to the hidden content of the second chat content or of the further instance of the first chat content.

Alternatively, another communication system with hidden content is provided, which may include a first device, a communication server, and a second device. The communication system with hidden content may be employed as follows. The first device generates a communication message and displays a first communication interface that includes the communication message. The communication message may in turn include viewable content and hidden content, and the hidden content is disposed with an unlock condition, which includes at least one non-time-restrictive condition. The first device connects to and transmits the communication message to the communication server. The communication server receives the communication message and, according to the communication message and the unlock condition that includes the non-time-restrictive condition, generates a concealed message including the hidden content that is not displayed. The communication server connects to and transmits the concealed message to the second device. The second device receives the concealed message and displays a second communication interface, which includes the concealed message. The second communication interface displays the hidden content in the concealed message when the unlock condition that includes the non-time-restrictive condition is satisfied.

Alternatively, another communication method with hidden content is provided in the present disclosure. The method may be applied to the communication system with hidden content. The communication system with hidden content may include a first device, a second device, and a communication server. The communication method with hidden content may include steps as follows: generating a communication message, which may have viewable content and hidden content, and setting an unlock condition, which includes at least one non-time-restrictive condition, corresponding to the hidden content; displaying a first communication interface that includes the communication message; generating, according to the hidden content and the unlock condition that includes the non-time-restrictive condition, a concealed message by the communication server, and delivering the concealed message to the second device; displaying a second communication interface that includes the concealed message; and when the unlock condition including the non-time-restrictive condition is satisfied, displaying the hidden content in the concealed message.

Alternatively, yet another communication system with hidden content is provided, which may include a first device and a second device. The communication system with hidden content may be employed as follows. The first device generates a communication message and displays a first communication interface, which includes the communication message. The communication message may include viewable content and hidden content, and the hidden content is disposed with an unlock condition. According to the communication message and the unlock condition, the first device generates an encrypted message including the hidden content that is not displayed. The first device connects to and transmits the encrypted message to the second device, and the second device receives the encrypted message and displays a second communication interface, which includes the encrypted message. The second communication interface displays the hidden content in the encrypted message when the unlock condition is satisfied.

In one preferred embodiment, the first device transmits first chat content to the second device, and the first chat content is displayed in the second communication interface. The second device transmits second chat content to the first device, and the second chat content is displayed in the first communication interface.

In one preferred embodiment, the unlock condition includes at least one non-time-restrictive condition.

In one preferred embodiment, an application program is installed on the first device, and the application program is logged into prior to generating the communication message.

In one preferred embodiment, the application program is installed in the second device to, for instance, display the second communication interface upon reception of the encrypted message.

In one preferred embodiment, the first device transmits the encrypted message to the second device that does not have the application program installed, by means of communication that do not correspond to the application program.

In one preferred embodiment, the first device is configured to assign at least one contact to receive the communication message and may generate a contact group according to the at least one contact.

In one preferred embodiment, the second or first device generates another encrypted message that also has an unlock condition and correspondingly includes hidden content of the second chat content or of the further instance of the first chat content.

Alternatively, yet another communication method with hidden content is provided in the present disclosure. The method may be applied to the communication system with hidden content. The communication system with hidden content may include a first device and a second device. The communication method with hidden content may include steps as follows: generating a communication message, which may have viewable content and hidden content, and setting an unlock condition corresponding to the hidden content; displaying a first communication interface that includes the communication message; generating, according to the hidden content and the unlock condition, an encrypted message by the first device, and delivering the encrypted message to the second device; displaying a second communication interface that includes the encrypted message; and when the unlock condition is satisfied, displaying the hidden content in the encrypted message.

In one preferred embodiment, the communication method with hidden content further includes the following steps: transmitting first chat content of the first device to the second device, and the first chat content is displayed in the second communication interface; and transmitting second chat content of the second device to the first device, and the second chat content is displayed in the first communication interface.

In one preferred embodiment, prior to generating the communication message, the communication method includes the following steps: installing on the first device an application program; and logging into the application program.

In one preferred embodiment, the application program is installed on the second device, and the communication method includes the following step: receiving the encrypted message and displaying the second communication interface accordingly by the second device.

In one preferred embodiment, the application program is not installed on the second device, and the communication method includes the following step: transmitting the encrypted message by means of communication that does not correspond to the application program.

In one preferred embodiment, prior to transmitting the second chat content or a further instance of the first chat content, the communication method includes the following steps: the corresponding second or first device generating the second chat content or the further instance of the first chat content that include hidden content, setting an unlock condition, and generating another encrypted message according to the hidden content of the second chat content or of the further instance of the first chat content.

By being able to send hidden content and setting a corresponding unlock condition, the communication system with hidden content and the method thereof may help generate interest and encourage replies to messages with hidden content and therefore promote further interaction between participants in a chat. Additionally, any prior agreements, such as deals or promises, can later be checked in the record of such chats. The communication system with hidden content and the method thereof may be used for such practical purposes, but may also be used for entertainment purposes.

### BRIEF DESCRIPTION OF THE DRAWINGS

FIG. 1 is a block diagram for the communication system with hidden content of the present disclosure.

FIG. 2 is a schematic diagram for the communication system with hidden content of the present disclosure.

FIG. 3 is a schematic diagram for the message editing interface of the communication system with hidden content of the present disclosure.

FIG. 4 is a schematic diagram for the message viewing interface of the communication system with hidden content of the present disclosure.

FIG. 5 is a first schematic diagram for the second communication interface according to the first embodiment of the communication system with hidden content of the present disclosure.

FIG. 6 is a second schematic diagram for the second communication interface according to the first embodiment of the communication system with hidden content of the present disclosure.

FIG. 7 is a schematic diagram for the contact selection interface of the communication system with hidden content of the present disclosure.

FIG. 8 is a schematic diagram for the second communication interface according to the second embodiment of the communication system with hidden content of the present disclosure.

FIG. 9 is a flowchart according to the first embodiment of the communication method with hidden content of the present disclosure.

FIG. 10 is a flowchart according to the second embodiment of the communication method with hidden content of the present disclosure.

FIG. 11 is a block diagram according to the third embodiment of the communication system with hidden content of the present disclosure.

FIG. 12 is a flowchart according to the third embodiment of the communication method with hidden content of the present disclosure.

### DESCRIPTION OF THE PREFERRED EMBODIMENTS

Reference will now be made in detail to the exemplary embodiments of the present disclosure, examples of which are illustrated in the accompanying drawings. Therefore, it is to be understood that the following is illustrative of exemplary embodiments and the invention is not to be construed as limited to the specific embodiments disclosed. That is, modifications to the disclosed exemplary embodiments, as well as other exemplary embodiments, are also intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and in the description to refer to the same or like parts. The terms first, second, etc. may be used herein to describe various elements, but these elements are not limited by these terms. These terms are used to distinguish one element from another element. Thus, a first element discussed herein could be termed a second element and vice versa without departing from the inventive concept disclosure herein.

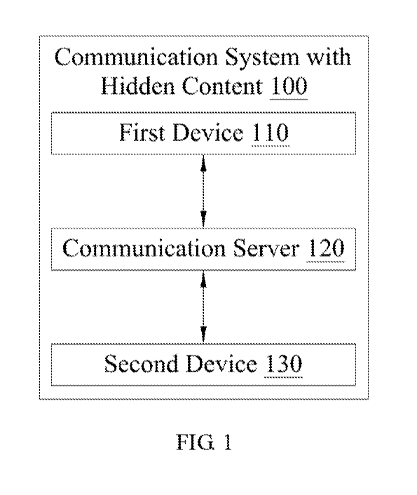

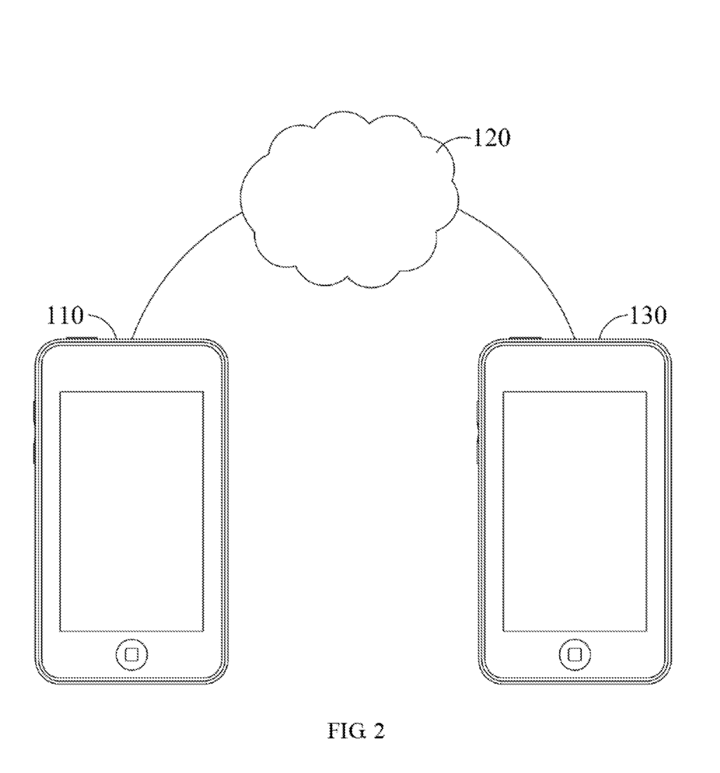

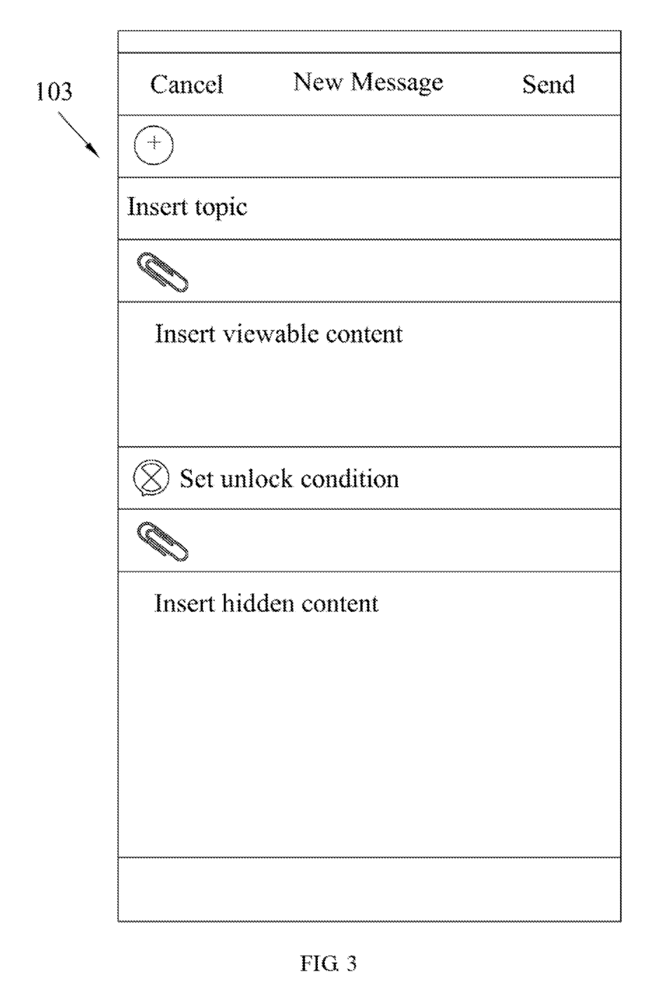

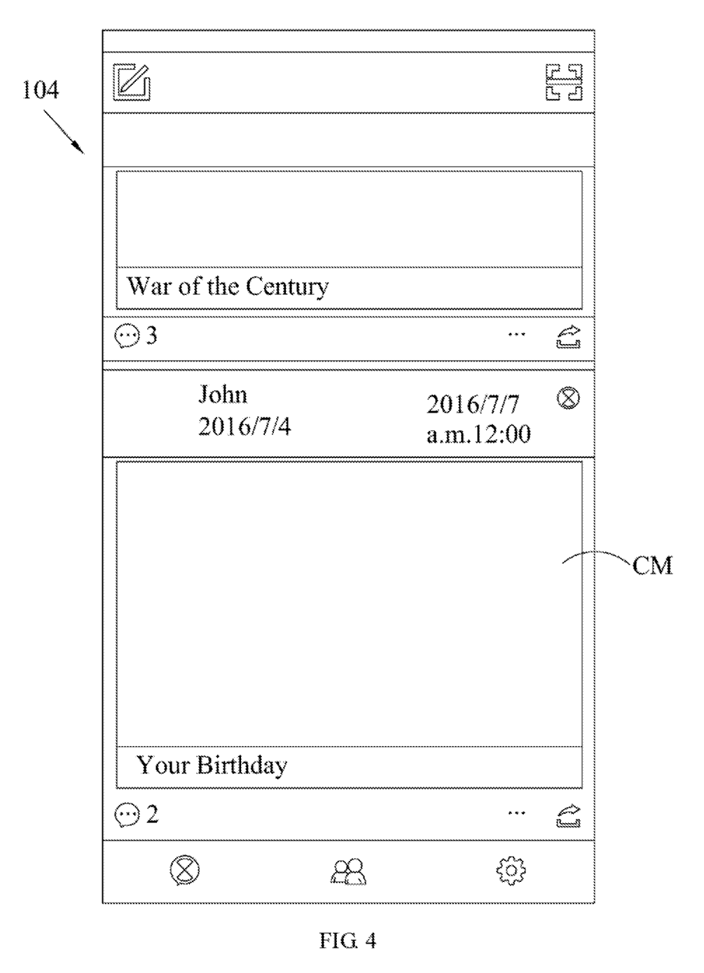

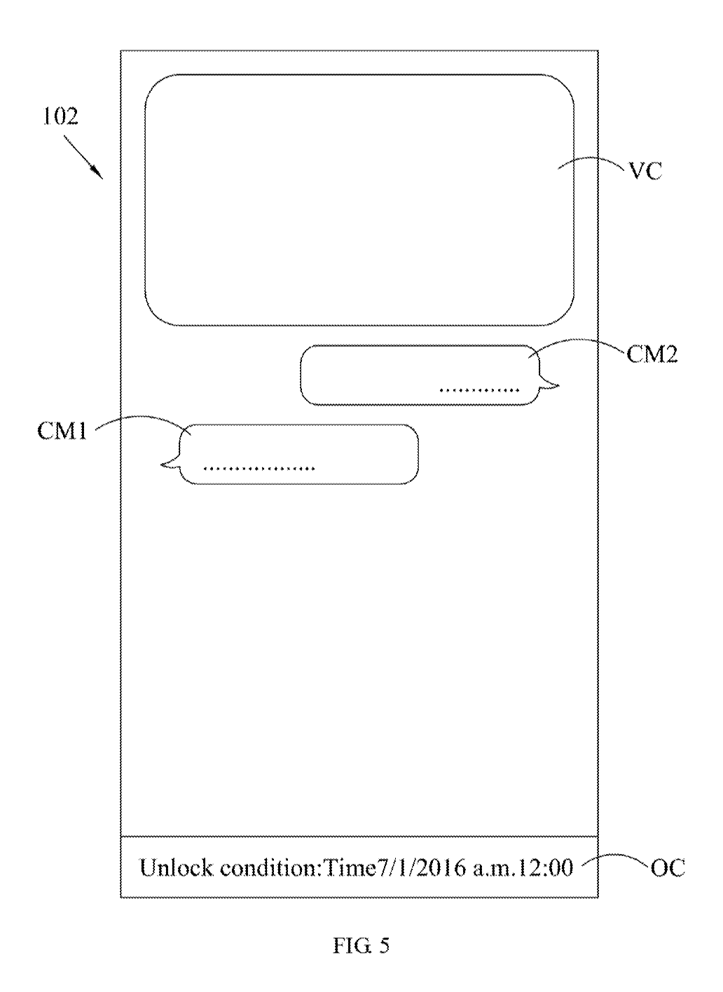

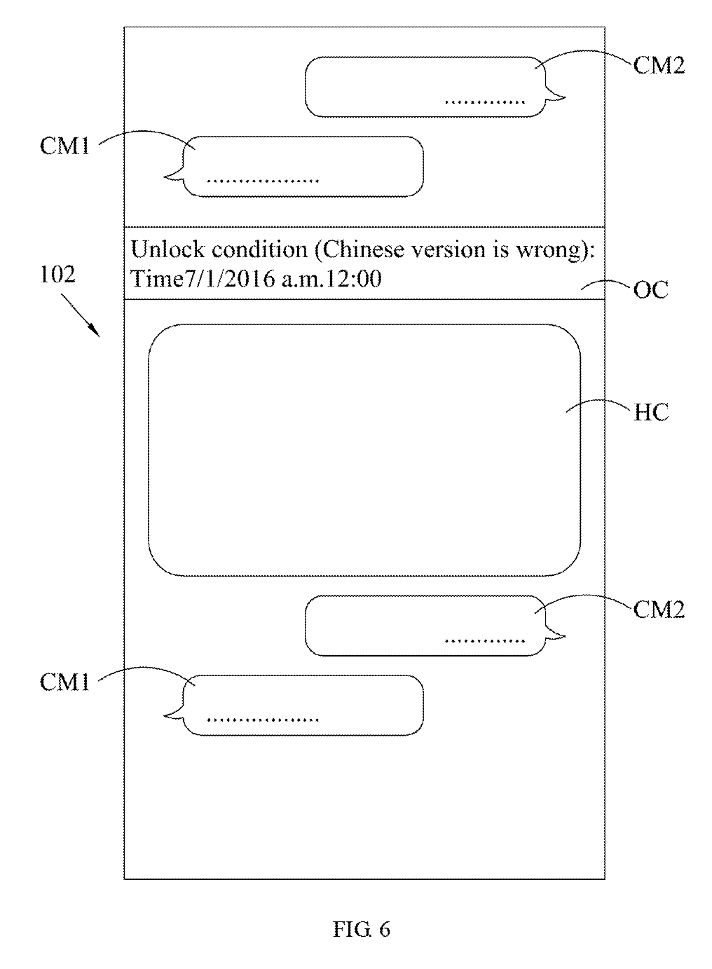

The following refers to FIGS. 1-6, where FIG. 1 is a block diagram for the communication system with hidden content; FIG. 2 is a schematic diagram for the communication system with hidden content; FIG. 3 is a schematic diagram for the message editing interface of the communication system with hidden content; FIG. 4 is a schematic diagram for the message viewing interface of the communication system with hidden content; FIG. 5 is a first schematic diagram for the second communication interface according to the first embodiment of the communication system with hidden content; and FIG. 6 is a second schematic diagram for the second communication interface according to the first embodiment of the communication system with hidden content of the present disclosure. As shown in the drawings, the communication system with hidden content 100 of the present disclosure may include a first device 110, a communication server 120, and a second device 130. The first device 110 and the second device 130 may be mobile telecommunication devices, computers or any other electronic devices with telecommunication, information input or output, and information display capabilities. In one embodiment, both the first and second devices may include memory, which may store information, programs, computer codes, computing results, etc., a processor or controller, which processes information, executes programs installed in the memory, encrypts or decrypts information, gives instructions to other components of the device, etc., a screen to display information, and an I/O device, communication module or transceiver for information input or output, however, the present disclosure is not limited thereto. The communication server 120 may be connected to the first device 110 and the second device 130 via a wired or wireless connection.

In addition, the first device 110 may generate a communication message and display a first communication interface that includes the communication message. The communication message may include viewable content VC and hidden content HC, and the hidden content HC is disposed with an unlock condition OC.

The first device 110 connects to and transmits the communication message to the communication server 120. The communication server 120 receives the communication message and, according to the communication message and the unlock condition OC, generates a concealed message with the hidden content HC that is not displayed to the user.

The communication server 120 connects to and transmits the concealed message to the second device 130. The second device 130 receives the concealed message and displays a second communication interface 102, which includes the concealed message. The second communication interface 102 displays the hidden content HC in the concealed message when the unlock condition OC is satisfied. However, the second device 130 receives the viewable content VC and the hidden content HC in their entirety from the first device 110 when receiving the concealed message. In other words, although the hidden content HC is not yet displayed as the unlock condition OC is not yet met, the hidden content HC may be stored on the second device 130. As a result, any user of the second device 130 may, for instance, pay money to unlock the hidden content HC, and then the communication server 120 may pass on a proportion of the payment money to the first device 110. In an alternative embodiment, the communication server 120 transmits the hidden content HC to the second device 130 only after the unlock condition OC is satisfied. In another alternative embodiment, when the unlock condition OC is satisfied, the communication server 120 sends notification to the second device 130, such that the second device 130 may then request the transmission of the hidden content HC. After the second device 130 has sent a request to the communication server 120, the communication server 120 may then transmit the hidden content HC to the second device 130. In a further alternative embodiment, the second device 130 sends the request to the communication server 120 directly when the unlock condition OC is met, and the communication server 120 may then transmit the hidden content HC to the second device 130. However, these embodiments are merely examples, and they do not limit the scope of the present invention.

The first device 110 may transmit first chat content CM1 through the communication server 120 to the second device 130, and the first chat content CM1 is then displayed in the second communication interface 102. The second device 130 may transmit second chat content CM2 through the communication server 120 to the first device 110, and the second chat content CM2 is then displayed in the first communication interface. In other words, a conversation may be established between the first device 110 and the second device 130, and the users of both first and second devices 110 and 130 are able to chat while waiting for the hidden content HC to be unlocked, as well as continue chatting after the hidden content HC has been unlocked. Furthermore, the second chat content CM2 or a further instance of first chat content may include another concealed message that also has an unlock condition. Therefore, the messages shown in the same communication interface may not be limited to the concealed message that is initially sent from the first device 110.

As shown in FIG. 3, the user of the first device 110 may enter a title, viewable content, hidden content, and the unlock condition for a new communication message in the message editing interface 103. The viewable content and the hidden content may include words, pictures, videos, sound recordings, websites or a combination thereof.

As shown in FIG. 4, after the communication message has been generated, the successfully posted communication message CM may be seen on the message viewing interface 104 for both the first and second device 110 and 130. Various details, such as the name of the sender, message time stamp, unlock condition, and message title, which in FIG. 4 are respectively shown as the example details “John”, “Jul. 4, 2016”, “Jul. 7, 2016” and “Your Birthday”, may be displayed on the message viewing interface 104. In addition, the user of the first or second device 110 or 130 may enter into their corresponding communication interface (i.e. the first communication interface or the second communication interface 102) by clicking or tapping on the communication message CM.

Therefore, it is preferable that an application program that corresponds to the communication server 120 is installed on the first device 110, and the application program may be logged into prior to generating the communication message CM. The means of logging in may be by entering personal details such as phone number, email address, or social media account username, but the present disclosure is not limited thereto. Additionally, the application program corresponding to the communication server 120 may also be installed on the second device 130, so as to receive the concealed message and then display the second communication interface 102 accordingly. On the other hand, for a second device 130 that does not have the application program installed, the communication server 120 then transmits the concealed message to that second device 130 by means of communication that does not correspond to the application program. The means of communication may include email, SMS (short message service), or MMS (multimedia messaging service). It is worth noting that, when the second device 130 without the application program receives the concealed message, the user of the second device 130 may only view the viewable content and may not be able to view the hidden content, even if the unlock condition has been met. That is because, in this case if the user of the second device 130 wishes to see the hidden content that is only shown when the unlock condition is met, the user is required to install the application program.

As shown in FIG. 5, for the second communication interface 102 of the second device 130, the unlock condition OC has not yet been met, and so the user only sees the viewable content VC and the conversation between both parties (the first chat content CM1 and the second chat content CM2). As can be seen in the drawing, the unlock condition OC of the communication message may be a time condition, e.g. the hidden content HC may be displayed at 12:00 AM on Jul. 7, 2016.

Therefore, as can be appreciated in FIG. 6, when the time has reached 12:00 AM on Jul. 7, 2016, the unlock condition is satisfied and the hidden content HC is displayed. Following the display of the hidden content HC, the users of both the first and second device 110 and 130 may continue to chat.

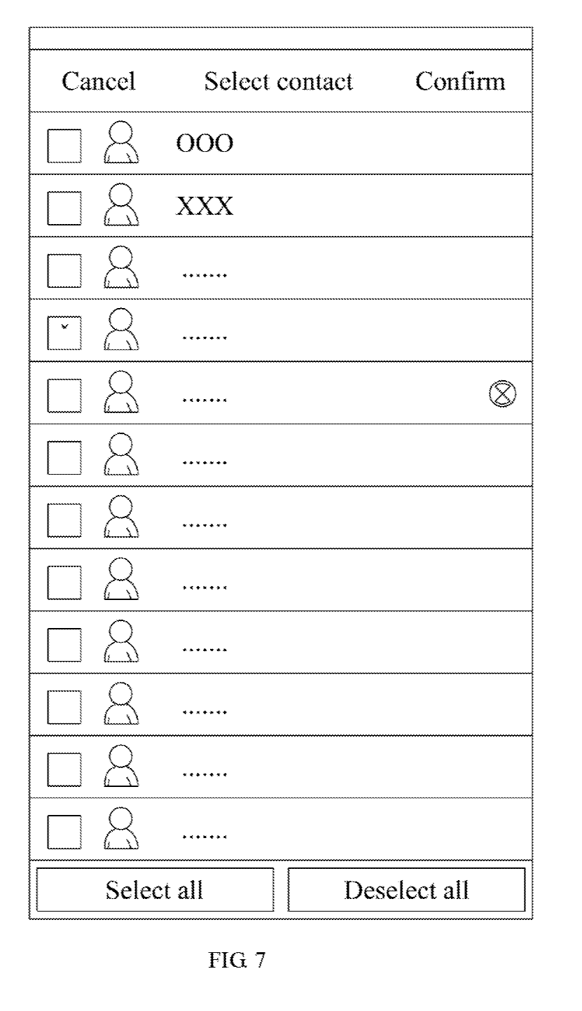

The following refers to FIG. 7, which is a schematic diagram for the contact selection interface of the communication system with hidden content of the present disclosure. After the first device 110 generates the communication message, the recipient of the message is required; in other words, at least one contact for the communication message is required as the recipient. Furthermore, the communication server 120 may generate a contact group according to the at least one contact. It is worth noting that it may not be necessary for the second device 130, that is the recipient's device or the devices corresponding to the at least one contact to have the application program installed.

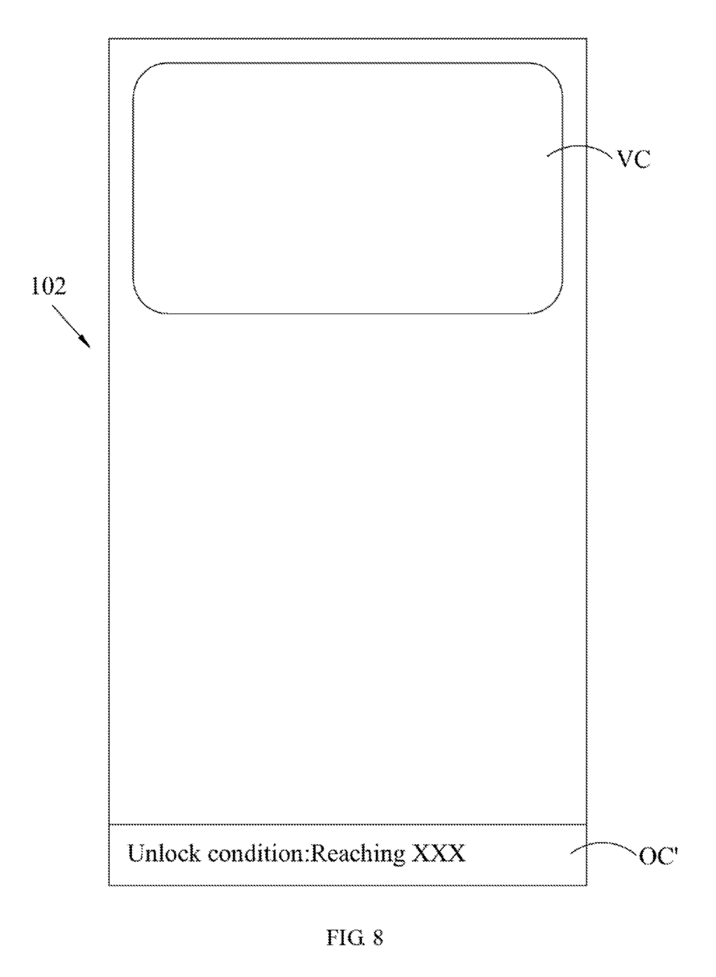

The following refers to FIG. 8, which is a schematic diagram for the second communication interface according to the second embodiment of the communication system with hidden content of the present disclosure. Based on the first embodiment, the second embodiment is further provided in the present disclosure to illustrate the present inventive concept. In the second embodiment, the communication system with hidden content may also include the first device, the communication server, and the second device. In contrast to the first embodiment, the hidden content in the communication message, which is generated by the first device of the present embodiment, includes an unlock condition OC′ with at least one non-time-restrictive condition. Therefore, the communication server may receive the communication message, and then according to the communication message and the unlock condition OC′ with the non-time-restrictive condition, the communication server may generate the concealed message with hidden content that may not be seen by the user at the receiving end, that is at the second device. The second device receives the concealed message, and then when the unlock condition OC′ with the non-time-restrictive condition is met, the second communication interface 102 of the second device displays the hidden content in the concealed message. As shown in the drawing, the unlock condition OC′ of the hidden content may be a condition of arriving at a certain location. In other words, in order to satisfy the unlock condition, the second device may be required to be in a specific location. However, this is merely an example, the unlock condition OC′ may also be a condition based on traveling speed, weather-related parameters, or physiological parameters instead of a location.

Although the communication method with hidden content of the present disclosure has been discussed in the aforementioned first and second embodiments of the communication system with hidden content, the corresponding flowcharts for the first and second embodiments, which follow, are provided for a more detailed description of such method.

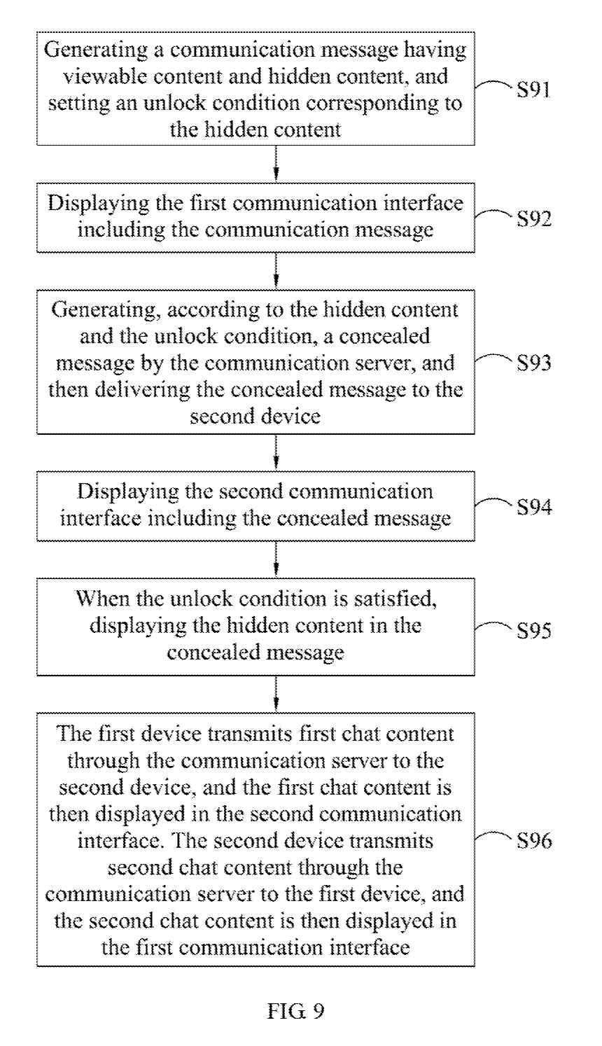

FIG. 9 is a flowchart according to the first embodiment of the communication method with hidden content of the present disclosure. As can be appreciated from the drawing, the communication method with hidden content of the present disclosure may be applied to the communication system with hidden content. The communication system with hidden content may include a first device, a second device, and a communication server. The communication method with hidden content may include the following steps:

Step S91: generating a communication message having viewable content and hidden content by the first device, and setting an unlock condition corresponding to the hidden content;

Step S92: displaying the first communication interface that includes the communication message, by the first device;

Step S93: generating, according to the hidden content and the unlock condition, a concealed message, and then delivering the concealed message to the second device, by the communication server;

Step S94: displaying the second communication interface that includes the concealed message, by the second device;

Step S95: when the unlock condition is satisfied, displaying the hidden content in the concealed message; and

Step S96: The first device transmits first chat content through the communication server to the second device, and the first chat content is then displayed in the second communication interface. The second device transmits second chat content through the communication server to the first device, and the second chat content is then displayed in the first communication interface.

Prior to generating the communication message, the application program that corresponds to the communication server is installed on the first device, and then the application program is logged into. Then, if the application program is installed on the second device, the second device receives the concealed message and displays the corresponding second communication interface. On the other hand, if the application program is not installed on the second device, the communication server may transmit the concealed message by means of communication that does not correspond to the application program.

Furthermore, after the first device generates the communication message, at least one contact is assigned to receive the communication message. Additionally, the communication server may generate a contact group according to the at least one contact. Next, the second or first device may correspondingly generate second chat content or a further instance of the first chat content that includes viewable content and hidden content. The communication server then generates another concealed message including the hidden content of the second chat content or of the further instance of the first chat content, sets the unlock condition for that concealed message and then transmits the second chat content or the further instance of the first chat content that includes the concealed message and unlock condition, the concealed message including hidden content.

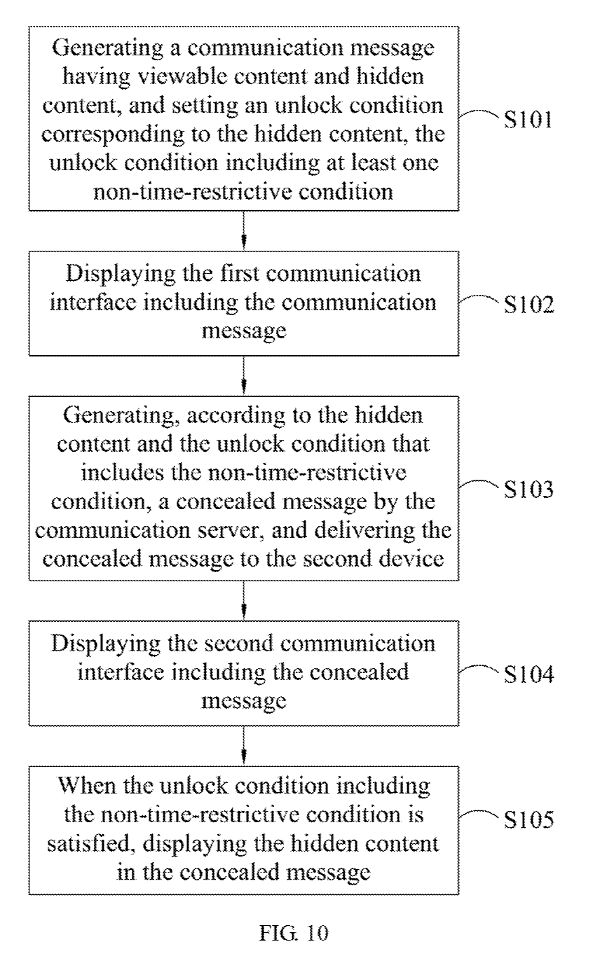

The following refers to FIG. 10, which is a flowchart according to the second embodiment of the communication method with hidden content of the present disclosure. As shown in the drawing, the communication method with hidden content for the second embodiment may include the following steps:

Step S101: generating a communication message having viewable content and hidden content by the first device, and setting an unlock condition corresponding to the hidden content, the unlock condition including at least one non-time-restrictive condition;

Step S102: displaying the first communication interface that includes the communication message, by the first device;

Step S103: generating, according to the hidden content and the unlock condition that includes the non-time-restrictive condition, a concealed message, and delivering the concealed message to the second device, by the communication server;

Step S104: displaying the second communication interface that includes the concealed message, by the second device; and

Step S105: when the unlock condition including the non-time-restrictive condition is satisfied, displaying the hidden content in the concealed message.

Many details of the communication method with hidden content and of the embodiments thereof have already been disclosed in the above description for the communication system, and are therefore not repeated here.

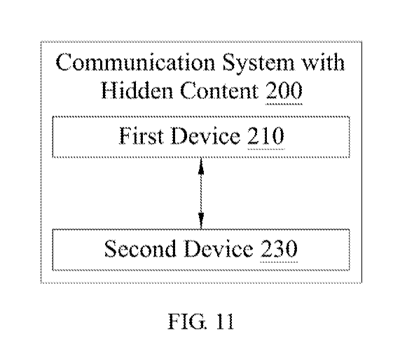

The following refers to FIG. 11, which is a block diagram according to the third embodiment of the communication system with hidden content of the present disclosure. Based on the first embodiment, the third embodiment is further provided in the present disclosure to illustrate the present inventive concept. In contrast to the first embodiment, the communication system with hidden content of the third embodiment may come without the communication server and only include the first device and the second device. Accordingly, as shown in the drawing, the communication system with hidden content 200 of the present embodiment includes the first device 210 and the second device 230.

The first device 210 may generate a communication message and display a first communication interface, which includes the communication message. The communication message may include viewable content and hidden content, and the hidden content is disposed with an unlock condition. According to the communication message and the unlock condition, the first device 210 may generate an encrypted message including the hidden content that is not displayed to the user.

The first device 210 may connect to and send the encrypted message to the second device 230. The second device 230 then receives the encrypted message and displays a second communication interface, which includes the encrypted message. The second communication interface displays the hidden content in the encrypted message when the unlock condition is satisfied.

The first device 210 may transmit the first chat content to the second device 230, and the first chat content is displayed in the second communication interface. The second device 230 may likewise transmit second chat content to the first device 210, and the second chat content is displayed in the first communication interface. Furthermore, the second chat content may include another encrypted message, a next encrypted message, also with an unlock condition. However, the next encrypted message is not limited to come from the second device 230, as the next encrypted message could come from the first device 210 instead. So, in addition to the encrypted message sent from the first device 210, further encrypted messages may be added to the first and second communication interfaces posted by the first or second devices 210 or 230. Furthermore, in a specific embodiment, the unlock condition may include at least one non-time-restrictive condition.

The application program is installed on the first device 210, and the application program may be logged into prior to generating the communication message, so that the communication message and the first chat content may be entered, the first communication interface may be displayed, and the encrypted message may be generated. The application program may also be installed on the second device 230, so that the second communication interface is displayed accordingly upon reception of the encrypted message, the second chat content may be entered, and the encrypted message is decrypted. In one embodiment, the encryption may be an asymmetric-key encryption (e.g. RSA encryption), but the present disclosure is not limited thereto, as a symmetric-key encryption may also be employed.

Moreover, the first device 210 may transmit the encrypted message to the second device 230 that does not have the application program by means of communication that does not correspond to the application program. In one embodiment, the first device 210 is configured to assign at least one contact to receive the communication message and may generate a contact group according to the at least one contact.

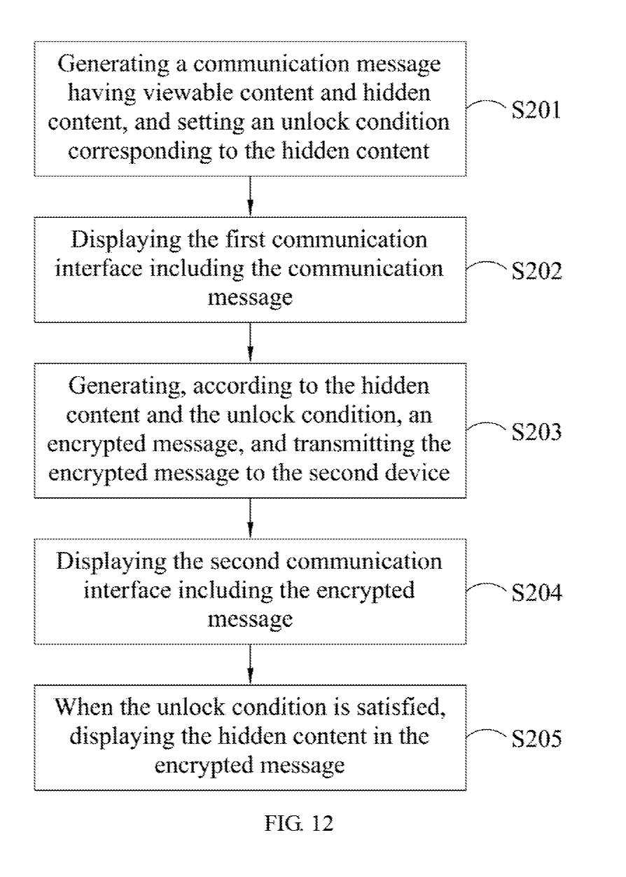

The following refers to FIG. 12, which is a flowchart according to the third embodiment of the communication method with hidden content of the present disclosure. As can be appreciated from the drawing, the communication method with hidden content of the third embodiment may be applied to the communication system with hidden content. In contrast to previous embodiments, the communication system with hidden content of the present embodiment only includes a first and second device. The communication method with hidden content may include the following steps:

Step S201: generating a communication message having viewable content and hidden content, and setting an unlock condition corresponding to the hidden content, by the first device;

Step S202: displaying the first communication interface that includes the communication message, by the first device;

Step S203: generating, according to the hidden content and the unlock condition, an encrypted message, and transmitting the encrypted message to the second device, by the first device;

Step S204: displaying the second communication interface that includes the encrypted message, by the second device; and

Step S205: when the unlock condition is satisfied, displaying the hidden content in the encrypted message.

In one preferred embodiment, the first device transmits first chat content to the second device, and the first chat content is displayed in the second communication interface. The second device transmits second chat content to the first device, and the second chat content is displayed in the first communication interface.

In addition, before generating the communication message, the application program is installed on the first device and logged into. Accordingly, if the application program is installed on the second device, the second device receives the encrypted message and displays the corresponding second communication interface. On the other hand, if the application program is not installed on the second device, the first device may transmit the encrypted message by means of communication that does not correspond to the application program. Furthermore, the unlock condition may include at least one non-time-restrictive condition.

The second chat content or a further instance of the first chat content may include another encrypted message also with an unlock condition.

Many details of the third embodiment of the communication method with hidden content have already been disclosed in the above description of the third embodiment of the communication system, and are therefore not repeated here.

Therefore, by being able to send hidden content and setting a corresponding unlock condition, the communication system with hidden content and the method thereof may help generate interest and encourage replies to messages with hidden content and therefore promote further interaction between participants in a chat. Additionally, any prior agreements, such as deals or promises, can later be checked in the record of such chats. The communication system with hidden content and the method thereof may be used for such practical purposes, but may also be used for entertainment purposes.

The communication system with hidden content, method thereof and alternate preferred embodiments of system and method thereof have been described above as including two devices. However, the inventive concept disclosed herein is not limited to two devices, as a person of ordinary skill in the art may easily see how the inventive concept may be extended to three or more devices participating in one conversation using the disclosed invention.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other aspects of functionality are envisioned and may fall within the scope of claims that follow. Finally, structures and functionality presented as discrete components in the exemplary configurations may be implemented as a combined structure or as standalone components. These and other variations, modifications, additions, and improvements may fall within the scope of the invention as defined in the claims that follow.

While the present disclosure is described with some preferred embodiments thereof, it is understood that many changes and modifications in the described embodiments can be carried out without departing from the scope and the spirit of the invention, which is intended to be limited only by the appended claims.

That is, the foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Although the terms first, second, third, etc. may be used herein to describe various elements, components, loops, circuits, and/or modules, these elements, components, loops, circuits, and/or modules should not be limited by these terms. These terms may be only used to distinguish one element, component, loop, circuit or module from another element, component, loop, circuit or module. Terms such as “first,” “second,” and other numerical terms when used herein do not imply a sequence or order unless clearly indicated by the context. Thus, a first element, component, loop, circuit or module discussed above could be termed a second element, component, loop, circuit or module without departing from the teachings of the example implementations disclosed herein.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

What is claimed is:

1. A communication system with hidden content, comprising:
a first device generating a communication message and displaying a first communication interface that comprises the communication message, the communication message comprising viewable content and hidden content, and the hidden content being disposed with an unlock condition;
a communication server connected to the first device, configured to receive the communication message, and, according to the communication message and the unlock condition, generating a concealed message comprising the hidden content that is not displayed; and
a second device connected to the communication server, and configured to receive the concealed message and display a second communication interface comprising the concealed message, the second communication interface displaying the hidden content in the concealed message when the unlock condition is satisfied;
wherein the first device transmits first chat content through the communication server to the second device, and the first chat content is displayed in the second communication interface, the second device transmits second chat content through the communication server to the first device, and the second chat content is displayed in the first communication interface.

2. The communication system with hidden content of claim 1, wherein an application program corresponding to the communication server is installed on the first device, and the application program is logged into prior to generating the communication message.

3. The communication system with hidden content of claim 2, wherein the application program is installed on the second device to, for instance, display the second communication interface upon receiving the concealed message.

4. The communication system with hidden content of claim 2, wherein the communication server transmits the concealed message to the second device that does not have the application program installed, by means of communication that do not correspond to the application program.

5. The communication system with hidden content of claim 1, wherein the first device is configured to assign at least one contact to receive the communication message, and the communication server generates a contact group according to the at least one contact.

6. The communication system with hidden content of claim 1, wherein the communication server generates another concealed message having another unlock condition, where the other encrypted message comprises hidden content of the second chat content or of a further instance of the first chat content.

7. A communication method with hidden content for a communication system with hidden content, wherein the communication system with hidden content comprises a first device, a second device, and a communication server, the communication method with hidden content comprising steps as follows:
generating a communication message having viewable content and hidden content by the first device, and setting an unlock condition corresponding to the hidden content;
displaying a first communication interface comprising the communication message by the first device;
generating, according to the hidden content and the unlock condition, a concealed message, and delivering the concealed message to the second device by the communication server;
displaying a second communication interface comprising the concealed message, by the second device; and
when the unlock condition is satisfied, displaying the hidden content in the concealed message;
wherein the first device transmits first chat content through the communication server to the second device, and the first chat content is displayed in the second communication interface, the second device transmits second chat content through the communication server to the first device, and the second chat content is displayed in the first communication interface.

8. The communication method with hidden content of claim 7, comprising the following steps prior to generating the communication message:
installing on the first device an application program corresponding to the communication server; and
logging into the application program.

9. The communication method with hidden content of claim 8, wherein the application program is installed on the second device, and the communication method comprises the following step:
receiving the concealed message and displaying the second communication interface accordingly by the second device.

10. The communication method with hidden content of claim 8, wherein the application program is not installed on the second device, and the communication method comprises the following step:
transmitting the concealed message by means of communication that do not correspond to the application program.

11. The communication method with hidden content of claim 7, wherein after the first device generates the communication message, the communication method comprises the following steps:
assigning at least one contact to receive the communication message; and
generating a contact group according to the at least one contact.

12. The communication method with hidden content of claim 7, comprising the following steps prior to transmitting the second chat content or a further instance of the first chat content:
generating the second chat content or the further instance of the first chat content comprising hidden content, correspondingly by the second or first device;
setting another unlock condition; and
generating by the communication server another concealed message having the other unlock condition, according to the hidden content of the second chat content or of a further instance of the first chat content.

13. A communication system with hidden content, comprising:
a first device generating a communication message and displaying a first communication interface that comprises the communication message, the communication message comprising viewable content and hidden content, the hidden content being disposed with an unlock condition that comprises at least one non-time-restrictive condition;
a communication server connected to the first device, configured to receive the communication message, and, according to the communication message and the unlock condition that comprises the non-time-restrictive condition, generating a concealed message with the hidden content that is not displayed; and
a second device connected to the communication server, and configured to receive the concealed message and display a second communication interface comprising the concealed message, the second communication interface displaying the hidden content in the concealed message when the unlock condition that comprises the non-time-restrictive condition is satisfied.

14. The communication system with hidden content of claim 13, wherein an application program corresponding to the communication server is installed on the first device, and the application program is logged into prior to generating the communication message.

15. The communication system with hidden content of claim 14, wherein the application program is installed on the second device to, for instance, display the second communication interface upon receiving the concealed message.

16. The communication system with hidden content of claim 14, wherein the communication server transmits the concealed message to the second device that does not have the application program installed, by means of communication that do not correspond to the application program.

17. The communication system with hidden content of claim 13, wherein the first device is configured to assign at least one contact to receive the communication message, and the communication server generates a contact group according to the at least one contact.

18. A communication method with hidden content for a communication system with hidden content, wherein the communication system with hidden content comprises a first device, a second device, and a communication server, the communication method with hidden content comprising steps as follows:
generating a communication message having viewable content and hidden content by the first device, and setting an unlock condition corresponding to the hidden content, the unlock condition comprising at least one non-time-restrictive condition;
displaying a first communication interface comprising the communication message by the first device;
generating, according to the hidden content and the unlock condition that comprises the non-time-restrictive condition, a concealed message, and delivering the concealed message to the second device by the communication server;
displaying a second communication interface comprising the concealed message, by the second device; and
when the unlock condition comprising the non-time-restrictive condition is satisfied, displaying the hidden content in the concealed message.

19. The communication method with hidden content of claim 18, comprising the following steps prior to generating the communication message:
installing on the first device an application program corresponding to the communication server; and
logging into the application program.

20. The communication method with hidden content of claim 19, wherein the application program is installed on the second device, and the communication method comprises the following step:
receiving the concealed message and displaying the second communication interface accordingly by the second device.

21. The communication method with hidden content of claim 19, wherein the application program is not installed on the second device, and the communication method comprises the following step:
transmitting the concealed message by means of communication that do not correspond to the application program.

22. The communication method with hidden content of claim 18, wherein after the first device generates the communication message, the communication method comprises the following steps:
assigning at least one contact to receive the communication message; and
generating a contact group according to the at least one contact.

23. A communication system with hidden content, comprising:
a first device generating a communication message and displaying a first communication interface that comprises the communication message, the communication message comprising viewable content and hidden content, the hidden content being disposed with an unlock condition, the first device generating an encrypted message comprising the hidden content that is not displayed according to the communication message and the unlock condition; and
a second device connected to the first device, the second device configured to receive the encrypted message and display a second communication interface comprising the encrypted message, the second communication interface displaying the hidden content in the encrypted message when the unlock condition is satisfied.

24. The communication system with hidden content of claim 23, wherein the first device transmits first chat content to the second device, and the first chat content is displayed in the second communication interface, the second device transmits second chat content to the first device, and the second chat content is displayed in the first communication interface.

25. The communication system with hidden content of claim 24, wherein the second or first device generates another encrypted message having another unlock condition, where the other encrypted message correspondingly comprises hidden content of the second chat content or of a further instance of the first content.

26. The communication system with hidden content of claim 23, wherein the unlock condition comprises at least one non-time-restrictive condition.

27. The communication system with hidden content of claim 23, wherein an application program is installed on the first device, and the application program is logged into prior to generating the communication message.

28. The communication system with hidden content of claim 27, wherein the application program is installed on the second device to, for instance, display the second communication interface upon receiving the encrypted message.

29. The communication system with hidden content of claim 27, wherein the first device transmits the encrypted message to the second device that does not have the application program installed, by means of communication that do not correspond to the application program.

30. The communication system with hidden content of claim 23, wherein the first device is configured to assign at least one contact to receive the communication message and generates a contact group according to the at least one contact.

31. A communication method with hidden content for a communication system with hidden content, wherein the communication system with hidden content comprises a first device and a second device, the communication method with hidden content comprising steps as follows:
generating a communication message having viewable content and hidden content, and setting an unlock condition corresponding to the hidden content, by the first device;
displaying a first communication interface comprising the communication message, by the first device;
generating, according to the hidden content and the unlock condition, an encrypted message, and delivering the encrypted message to the second device, by the first device;
displaying a second communication interface comprising the encrypted message, by the second device; and
when the unlock condition is satisfied, displaying the hidden content in the encrypted message.

32. The communication method with hidden content of claim 31, further comprising the following steps:
transmitting first chat content of the first device to the second device, and the first chat content is displayed in the second communication interface; and
transmitting second chat content of the second device to the first device, and the second chat content is displayed in the first communication interface.

33. The communication method with hidden content of claim 32, comprising the following steps prior to transmitting the second chat content or a further instance of the first chat content:
generating the second chat content or a further instance of the first chat content comprising hidden content;
setting another unlock condition; and
generating another encrypted message having the other unlock condition, according to the hidden content of the second chat content or of the further instance of the first chat content, correspondingly by the second or first device.

34. The communication method with hidden content of claim 31, wherein the unlock condition comprises at least one non-time-restrictive condition.

35. The communication method with hidden content of claim 31, comprising the following steps prior to generating the communication message:
installing on the first device an application program; and
logging into the application program.

36. The communication method with hidden content of claim 35, wherein the application program is installed on the second device, and the communication method comprises the following step:
receiving the encrypted message and displaying the second communication interface accordingly by the second device.

37. The communication method with hidden content of claim 35, wherein the application program is not installed on the second device, and the communication method comprises the following step:
transmitting the encrypted message by means of communication that do not correspond to the application program.

38. The communication method with hidden content of claim 31, wherein after the first device generates the communication message, the communication method comprises the following steps:
assigning at least one contact to receive the communication message; and
generating a contact group according to the at least one contact.
